(19) United States
(12) Patent Application Publication
(10) Pub. No.: US 2025/0007219 A1
(43) Pub. Date: Jan. 2, 2025

(54) COMMUNICATION CONNECTOR APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Akira MIYAJO, Yokkaichi-shi, Mie (JP); Makoto MASHITA, Yokkaichi-shi, Mie (JP); Takeshi HAGIHARA, Yokkaichi-shi, Mie (JP); Hirofumi URAYAMA, Yokkaichi-shi, Mie (JP); Masakatsu MORIGUCHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 18/709,615

(22) PCT Filed: Oct. 27, 2022
(86) PCT No.: PCT/JP2022/040157

§ 371 Date: May 13, 2024

(30) Foreign Application Priority Data
Nov. 17, 2021 (JP) 2021-187023

(51) Int. Cl. H01R 13/6466; H01R 24/64

(52) U.S. Cl. CPC H01R 13/6466; H01R 24/64; H01R 2201/26

(57) ABSTRACT

According to the present disclosure, it is possible to accommodate changes in communication devices without replacing a circuit substrate. A communication connector apparatus includes: a circuit substrate having a substrate-side connector mounted thereon; and a relay connector including a connection port to which a device-side connector of a communication conductive path is to be connected, and being attachable to and removable from the substrate-side connector. In the case of changing the number and the transmission speed of communication devices, the relay connector may be replaced with a relay connector corresponding to the number and the transmission speed of the connection ports, and there is no need to replace the circuit substrate. According to the present disclosure, it is possible to accommodate changes in the communication devices without replacing the circuit substrate.

### CROSS-REFERENCE TO RELATED APPLICATIONS

This application is the U.S. national stage of PCT/JP2022/040157 filed on Oct. 27, 2022, which claims priority of Japanese Patent Application No. JP 2021-187023 filed on Nov. 17, 2021, the contents of which are incorporated herein.

### TECHNICAL FIELD

The present disclosure relates to a communication connector apparatus.

### BACKGROUND

JP 2021-061188A discloses a substrate connector including a resin housing that holds terminals, and fixing fittings that are press-fitted into side walls of the housing. The substrate connector is attached to a substrate by soldering the fixing fittings to the substrate.

The above-described substrate connector can be used for an in-vehicle communication circuit based on Ethernet (registered trademark). In this case, the number of devices to be connected to the in-vehicle communication circuit varies depending on the grade and the number of options of a vehicle, and therefore the number of communication ports of the substrate connector needs to be changed according to the number of the devices to be connected. Since the substrate connector is fixed to the substrate by means of soldering, changing the number of communication ports requires replacing not only the substrate connector, but also the substrate.

The communication connector apparatus according to the present disclosure has been completed in light of the above-described circumstances, and an object thereof is to accommodate changes in communication devices without replacing a substrate.

### SUMMARY

A communication connector apparatus according to the present disclosure includes a circuit substrate having a substrate-side connector mounted thereon; and a relay connector including a connection port to which a device-side connector of a communication conductive path is to be connected, and being attachable to and removable from the substrate-side connector.

### Advantageous Effects

According to the present disclosure, it is possible to accommodate changes in communication devices without replacing a circuit substrate.

### BRIEF DESCRIPTION OF DRAWINGS

FIG. 1 is a perspective view of a communication connector apparatus in a first assembled configuration according to Embodiment 1, as viewed obliquely from above and front.

FIG. 2 is a perspective view of a separated state of a housing used for the first assembled configuration, as viewed obliquely from above and front.

FIG. 3 is a perspective view of the first assembled configuration with the housing removed therefrom, as viewed obliquely from above and front.

FIG. 4 is a perspective view of a separated state of a housing used for a second assembled configuration, as viewed obliquely from above and front.

FIG. 5 is a front view of a communication connector apparatus in the second assembled configuration.

FIG. 6 is a perspective view of a state in which a first relay connector and a holding member for the first assembled configuration are removed from a circuit substrate, as viewed obliquely from above and front.

FIG. 7 is a perspective view of a disassembled state of the first relay connector used for the first assembled configuration, as viewed obliquely from above and front.

FIG. 8 is a perspective view of the first relay connector used for the first assembled configuration, as viewed obliquely from above and rear.

FIG. 9 is a perspective view of a disassembled state of the first relay connector used for the first assembled configuration, as viewed obliquely from above and rear.

FIG. 10 is a perspective view of the first relay connector and the holding member used for the first assembled configuration, as viewed obliquely from below and front.

FIG. 11 is a perspective view of a separated state of a front member and a retainer used for the first assembled configuration, as viewed obliquely from below and front.

FIG. 12 is a cross-sectional side view showing a state in which the first relay connector used for the first assembled configuration is attached to the circuit substrate.

FIG. 13 is a cross-sectional side view showing a state in which the locking by the retainer is released to enable the first relay connector to be disengaged from the circuit substrate in the first assembled configuration.

FIG. 14 is a bottom view showing a state in which the first relay connector used for the first assembled configuration is attached to the circuit substrate.

FIG. 15 is a bottom view showing a state in which the locking by the retainer is released to enable the first relay connector to be disengaged from the circuit substrate in the first assembled configuration.

FIG. 16 is a perspective view of the holding member as viewed obliquely from below and front.

FIG. 17 is a block diagram showing a configuration of a communication circuit in the first assembled configuration.

FIG. 18 is a block diagram showing a configuration of a communication circuit in the second assembled configuration.

FIG. 19 is a front view of a communication connector apparatus in a first assembled configuration according to Embodiment 2.

FIG. 20 is a front view of a communication connector apparatus in a second assembled configuration according to Embodiment 2.

FIG. 21 is a perspective view of a relay connector used for a first assembled configuration according to Embodiment 3, as viewed obliquely from above and front.

FIG. 22 is a front view of a communication connector apparatus in the first assembled configuration according to Embodiment 3.

FIG. 23 is a front view of a communication connector apparatus in a second assembled configuration according to Embodiment 3.

FIG. 24 is a perspective view of a communication connector apparatus according to Embodiment 4, as viewed obliquely from above and front.

FIG. 25 is a perspective view of a relay connector according to Embodiment 4.

FIG. 26 is a plan view of the communication connector apparatus according to Embodiment 4.

### DETAILED DESCRIPTION OF PREFERRED EMBODIMENTS

First, embodiments of the present disclosure will be listed and described.

In a first aspect, a communication connector apparatus according to the present disclosure includes a circuit substrate having a substrate-side connector mounted thereon; and a relay connector including a connection port to which a device-side connector of a communication conductive path is to be connected, and being attachable to and removable from the substrate-side connector. With the configuration according to the present disclosure, in the case of changing the number and the transmission speed of the communication devices, the relay connector may be replaced with a relay connector corresponding to the number and the transmission speed of the connection ports, and there is no need to replace the circuit substrate. According to the present disclosure, it is possible to accommodate changes in the communication devices without replacing the circuit substrate.

In a second aspect, it is preferable that the communication connector apparatus according to the first aspect further includes a housing configured to accommodate the circuit substrate and the relay connector, wherein the housing includes a housing body that is open on a front side thereof, and a front cover that is attachable to and removable from the opening of the housing body, the relay connector includes a hood portion configured to surround the connection port, and the front cover has a connection opening formed therein to expose the hood portion to an exterior of the housing. With this configuration, in the case of replacing the relay connector with a relay connector having a different number of connection ports, only the front cover may be replaced with a front cover having a connection opening matching the size of the hood portion, instead of replacing the entire housing. This can prevent a large gap from being formed between the connection opening and the hood portion.

In a third aspect, it is preferable that the communication connector apparatus according to the first aspect further includes a housing configured to accommodate the circuit substrate and the relay connector, the relay connector includes a hood portion configured to surround the connection port, the housing has a connection opening formed therein to expose the hood portion to an exterior of the housing, and the connection opening is provided with a movable cover that is displaceable so as to change an opening region of the connection opening. With this configuration, in the case of replacing the relay connector with a different relay connector having a different number of connection ports, the movable cover is displaced according to the size of the hood portion. This can prevent a large gap from being formed between the connection opening and the hood portion.

In a fourth aspect, it is preferable that the movable cover according to the third aspect is linked to the housing via a hinge. This configuration allows the movable cover to be displaced with the hinge serving as a support, thus changing the opening size of the connection opening.

In a fifth aspect, it is preferable that the communication connector apparatus according to the first aspect further includes a housing configured to accommodate the circuit substrate and the relay connector, wherein the relay connector includes a hood portion configured to surround the connection port, the housing has a connection opening formed therein to expose the hood portion to an exterior of the housing, and a covering portion configured to cover a part of the connection opening is provided as a single piece with the hood portion. With this configuration, by determining whether or not to provide the covering portion and setting the size of the covering portion according to the size of the hood portion, it is possible to prevent a large gap from being formed between the connection opening and the hood portion, without changing the size of the connection opening.

In a sixth aspect, it is preferable that the relay connector according to the first through the fifth aspects includes an outer conductor, and a sub-substrate configured to be connected to the substrate-side connector, and the outer conductor is disposed so as to cover the sub-substrate. With this configuration, the communication circuit can be stabilized by the shielding function of the outer conductor.

In a seventh aspect, it is preferable that the circuit substrate according to the first through the sixth aspects is provided with a holding member configured to hold the relay connector in a positioned state. With this configuration, it is possible to stably hold the relay connector that is attachable to and removed from the circuit substrate, and thus to provide a reliable connection between the relay connector and the substrate-side connector.

In an eighth aspect, it is preferable that the relay connector according to the seventh aspects includes an outer conductor, the outer conductor is connected to the holding member, and the holding member is made of a conductive material, is connected to a ground circuit of the circuit substrate, has a box shape, and covers the relay connector. With this configuration, the holding member also has a shielding function, and therefore a fewer number of components are required than in the case of providing a dedicated shielding function member separately from the holding member.

In a ninth aspect, it is preferable that the relay connector according to the first through the eighth aspects includes a retainer configured to be locked to the circuit substrate to hold the relay connector in an attached state to the circuit substrate, and the circuit substrate is provided with a disengagement pressing portion configured to press the relay connector in a direction in which the relay connector is disengaged from the circuit substrate. With this configuration, simply detaching the retainer from the circuit substrate allows the relay connector to be disengaged from the circuit substrate by the disengagement pressing portion. Accordingly, the disengagement can be performed with good workability.

In a tenth aspect, it is preferable that the relay connector according to the first through the ninth aspects includes an inner conductor, a dielectric, an outer conductor, and a sub-substrate, the sub-substrate includes a first sub-substrate disposed so as to be overlaid on a back surface of the dielectric, and a second sub-substrate connected to the first sub-substrate via a flexible cable, and a protection portion configured to cover a part of the flexible cable that protrudes from a peripheral edge of the first sub-substrate is formed on the dielectric. This configuration can prevent the flexible cable from being deformed due to interference with a foreign object.

### Embodiment 1

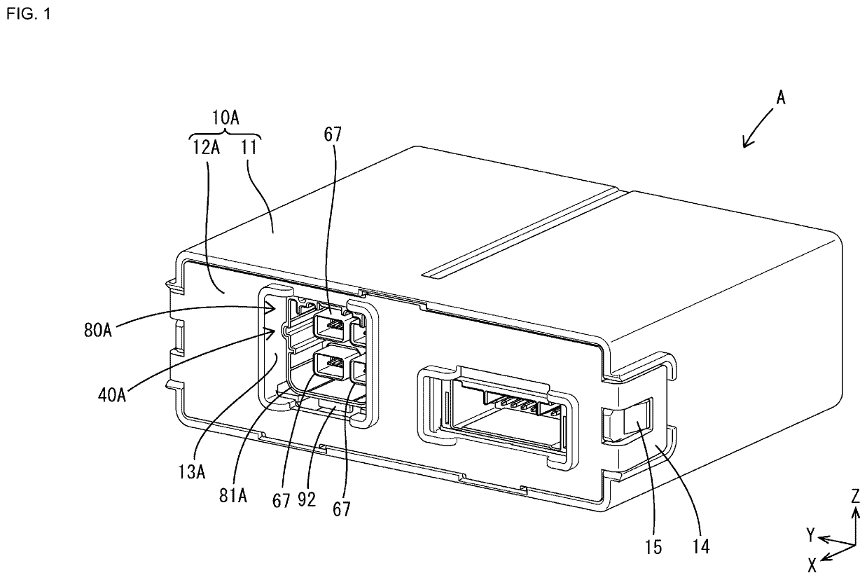

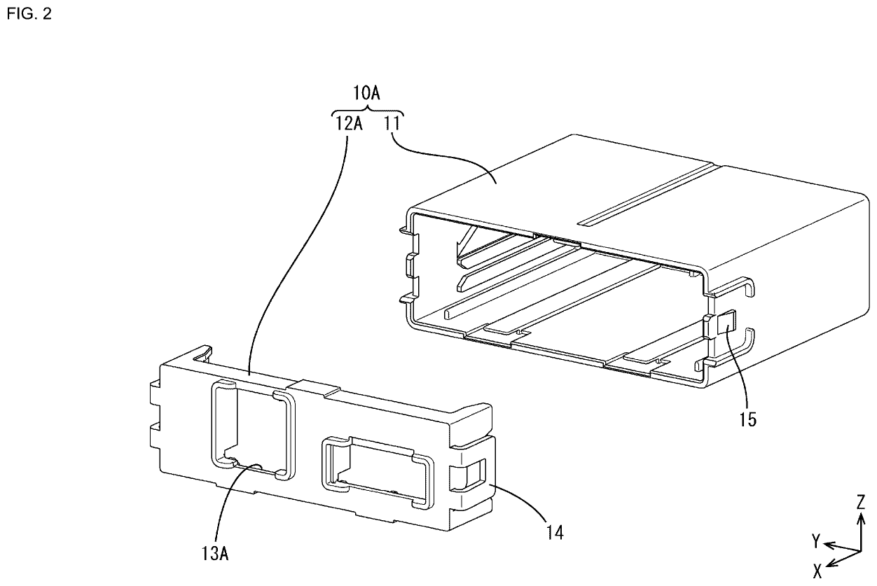

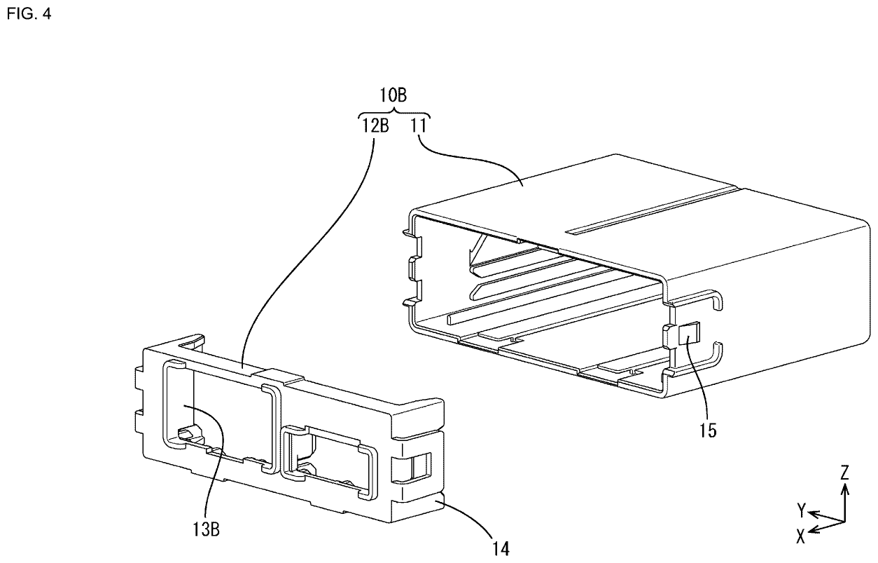

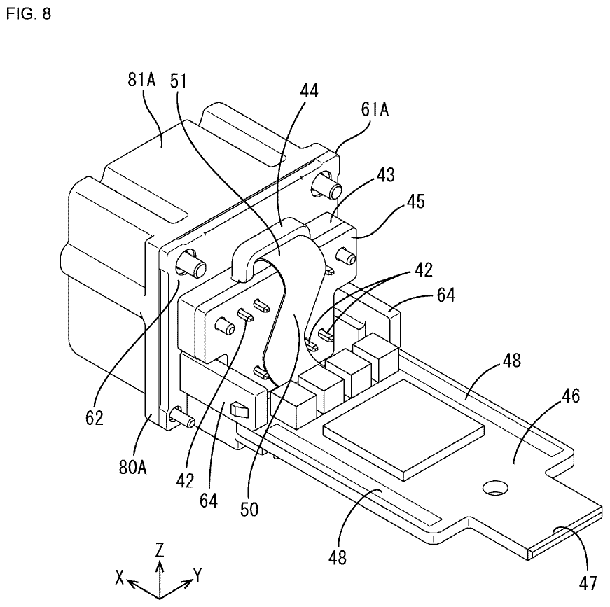

Embodiment 1 as an implementation of the present disclosure will be described with reference to FIGS. 1 to 18. It should be noted that the present disclosure is not limited to these examples, but is defined by the claims, and is intended to include all modifications which fall within the scope of the claims and the meaning and scope of equivalents thereof. In Embodiment 1, as for a front-rear direction, the positive direction of the X axis in FIGS. 1 to 4, and 6 to 16 is defined as the forward direction. As for a left-right direction, the positive direction of the Y axis in FIGS. 1 to 11, and 14 to 16 is defined as the rightward direction. As for an up-down direction, the positive direction of the Z axis in FIGS. 1 to 13, and 16 is defined as the upward direction.

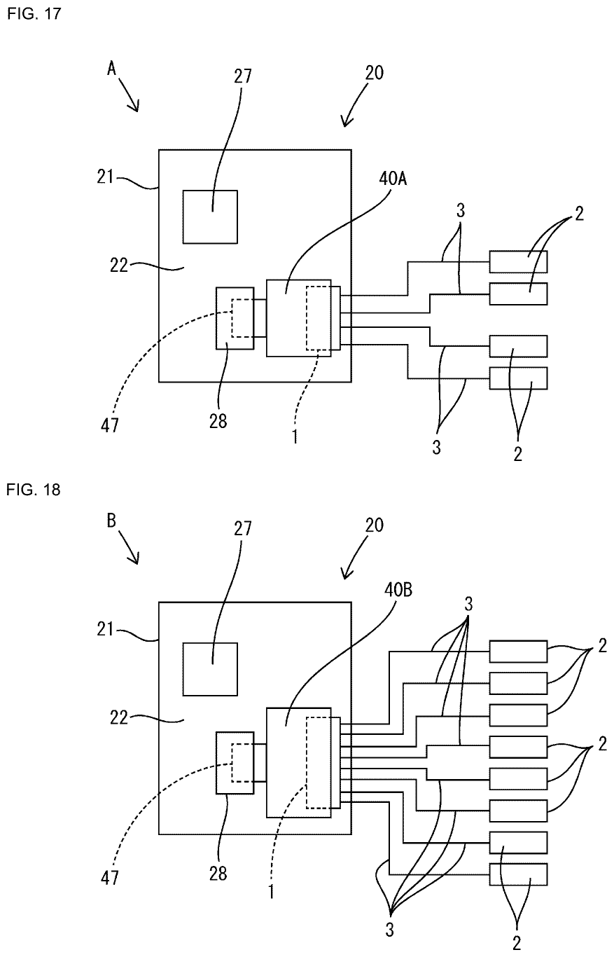

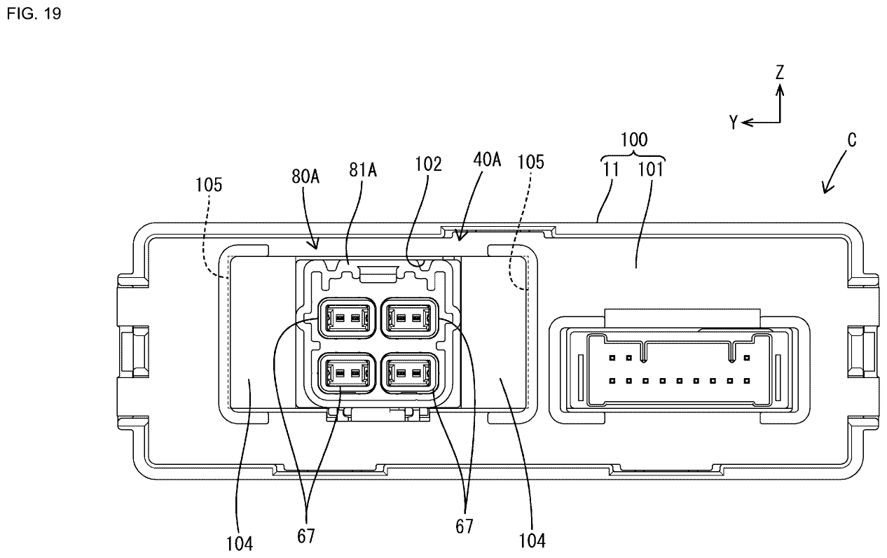

Communication connector apparatuses A and B according to Embodiment 1 are mounted in, for example, an automobile, and constitute an in-vehicle communication circuit for automatic driving control based on Ethernet (registered trademark). The communication connector apparatuses A and B are each formed by combining a housing 10A or 10B, a substrate unit 20, which is a common component, and one relay connector 40A or 40B that is freely selected from a plurality of types of relay connectors having different numbers of connection ports 67 in accordance with the application. In Embodiment 1, a first assembled configuration (see FIG. 17) in which a first relay connector 40A including four connection ports 67 is attached to a substrate unit 20, and a second assembled configuration (see FIG. 18) in which a second relay connector 40B including eight connection ports 67 is attached to a substrate unit 20 will be described as examples of the assembled configuration of the communication connector apparatuses A and B.

As shown in FIGS. 17 and 18, a device-side connector 1 is connected to each of the relay connectors 40A and 40B. Device-side ECUs (Electronic Control Units) provided in a plurality of communication devices 2 used for automatic driving control are connected to the device-side connector 1 via a plurality of communication conductive paths 3. The devices for automatic driving control include LiDAR (Light Detection and Ranging) devices. The communication conductive paths 3 are each formed by a wire harness that is routed outside the substrate unit 20. One communication conductive path 3 connects one connection port 67 and one communication device 2 to each other. Since the number of communication devices 2 varies depending on the grade and the number of options of a vehicle, the number of connection ports 67 of each of the relay connectors needs to be changed according to the number of communication devices 2 to be connected. The relay connectors 40A and 40B can be attached to and removed from the substrate unit 20 as necessary, and it is therefore possible to accommodate variations in the number of connection ports 67 without replacing the substrate unit 20, which is a common structure.

The substrate units 20 and the relay connectors 40A and 40B are accommodated in the housings 10A and 10B. As shown in FIGS. 1, 2, 4, and 5, the housings 10A and 10B are each formed by assembling a housing body 11, which is a common component, and one of two types of front covers 12A and 12B that conforms to the selected relay connectors 40A or 40B. The housing body 11 is made of synthetic resin, and has a rectangular parallelepiped shape that is open on the front side. Each of the first front cover 12A and the second front cover 12B is a plate-shaped component made of synthetic resin, and is mounted to the housing body 11 so as to close the opening on the front side.

The first front cover 12A constituting a part of the first housing 10A has a first connection opening 13A formed therein to expose the connection ports 67 of the first relay connector 40A. The housing body 11 and the first front cover 12A are held in an assembled state by elastic lock pieces 14 at left and right ends of the first front cover 12A being locked to lock projections 15 of the housing body 11. The second front cover 12B constituting a part of the second housing 10B has a second connection opening 13B formed therein to expose the connection ports 67 of the second relay connector 40B. The second connection opening 13B has an opening area larger than that of the first connection opening 13A. Portions of the second front cover 12B other than the second connection opening 13B are identical in shape and size to the corresponding portions of the first front cover 12A.

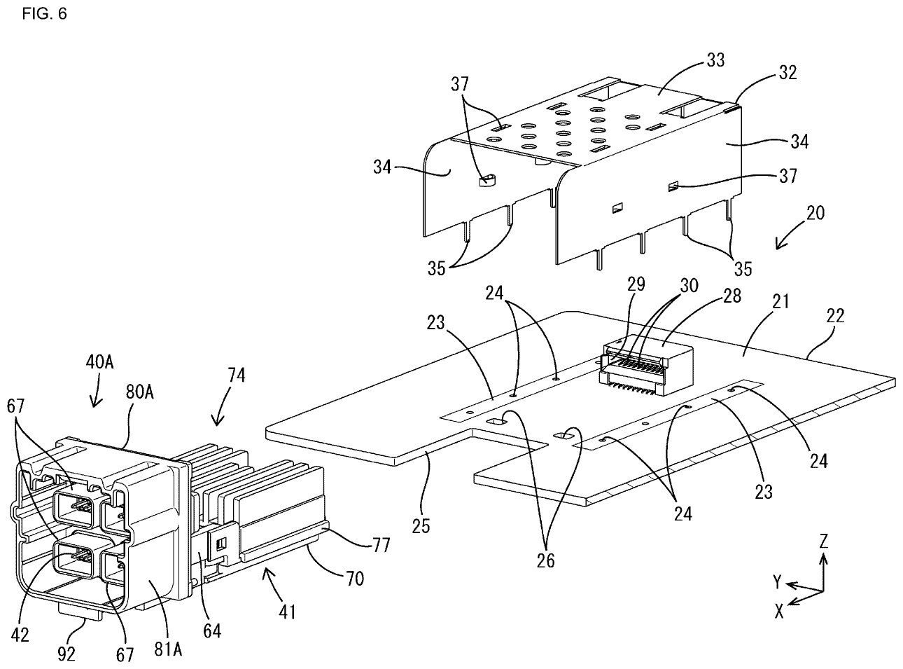

As shown in FIGS. 17 and 18, the substrate unit 20 includes a circuit substrate 21, a circuit 27, and a substrate-side connector 28. For convenience, in Embodiment 1, the circuit substrate 21 is assumed to be fixed in a horizontal orientation inside the housing body 11. The upper surface of the circuit substrate 21 functions as a mounting surface 22. As shown in FIG. 6, a pair of main ground circuits 23 extending in the front-rear direction are formed on the mounting surface 22. The two main ground circuits 23 are arranged so as to be spaced apart in the left-right direction. A plurality of connection holes 24 extending through the circuit substrate 21 are formed in regions of the circuit substrate 21 in which the main ground circuits 23 are formed. The plurality of connection holes 24 are arranged so as to be spaced apart in the front-rear direction.

The circuit substrate 21 has a cut-out portion 25 formed therein so as to be open at a front edge of the circuit substrate 21. The formation range of the cut-out portion 25 in the front-rear direction extends from the front edge of the circuit substrate 21 to a position rearward of front ends of the main ground circuits 23. In the left-right direction, the cut-out portion 25 is disposed between the two main ground circuits 23. In a plan view of the circuit substrate 21 as viewed from above, the cut-out portion 25 has a rectangular shape. The circuit substrate 21 has a pair of locking holes 26 formed therein so as to be spaced apart in the left-right direction. The pair of locking holes 26 are disposed at positions rearward of, and adjacent to the cut-out portion 25.

The circuit 27 includes a system on a chip (SOC), a system in a package (SiP), or the like, and is mounted on the mounting surface 22 (see FIGS. 17 and 18). The substrate-side connector 28 is mounted on the mounting surface 22. The circuit 27 and the substrate-side connector 28 may or may not be electrically connected to each other. The substrate-side connector 28 and each of the relay connectors 40A and 40B constitute a card edge connector. As shown in FIG. 6, the substrate-side connector 28 is disposed between the two main ground circuits 23 in the left-right direction. The substrate-side connector 28 is located rearward of the cut-out portion 25 and the locking holes 26, and is disposed forward of the connection holes 24 located at the rearmost end. The substrate-side connector 28 has a substrate accommodating space 29. The substrate accommodating space 29 is open on the front side of the substrate-side connector 28 so as to form a slit that is elongated in the left-right direction. The substrate-side connector 28 accommodates a plurality of terminal fittings 30 facing the interior of the substrate accommodating space 29.

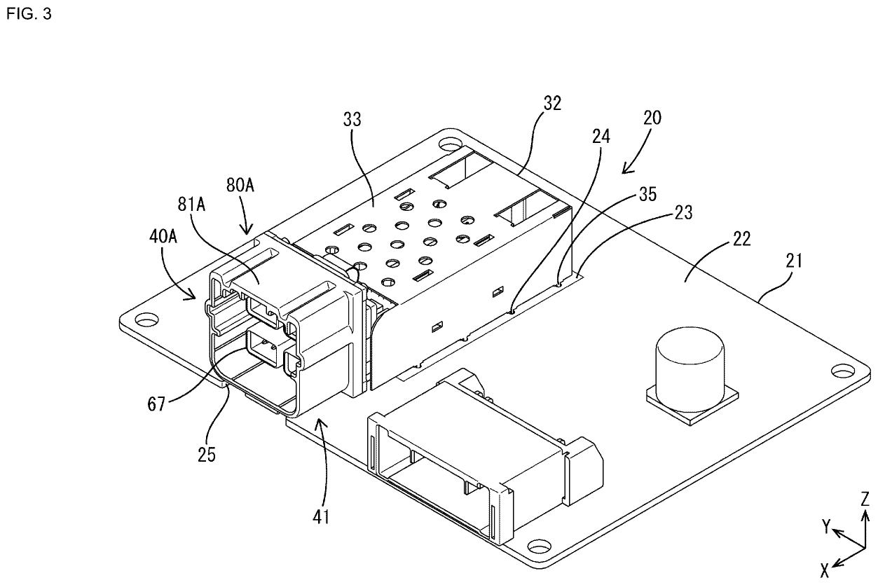

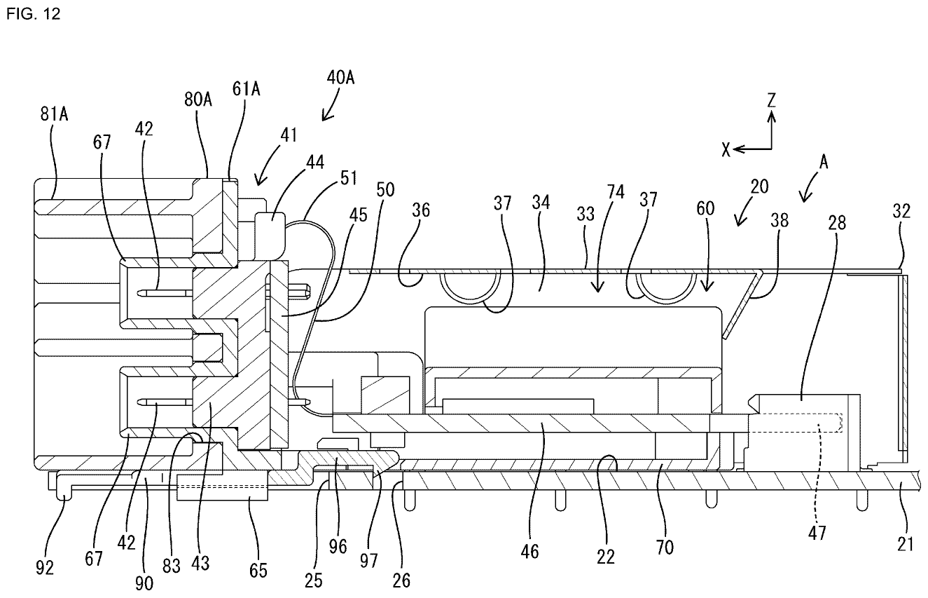

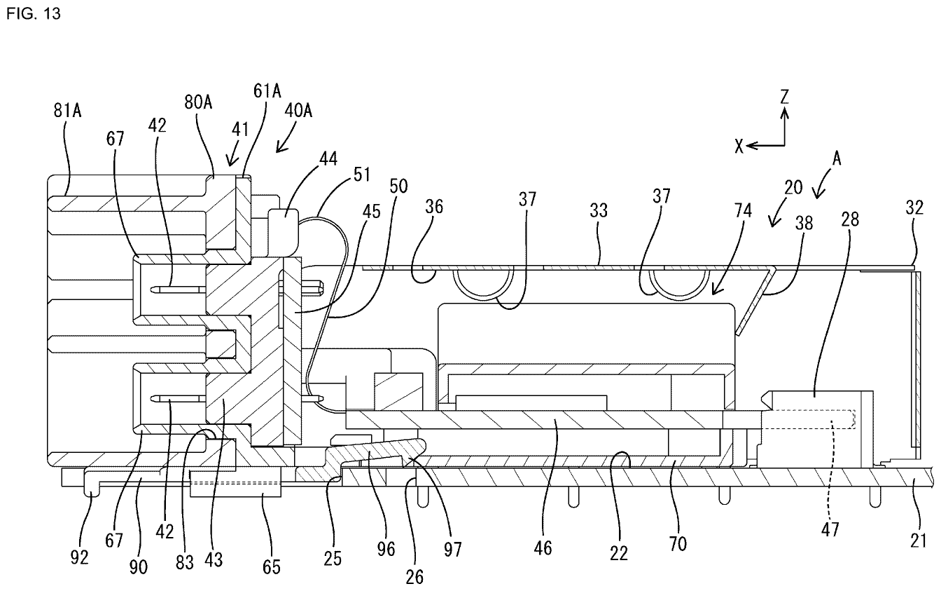

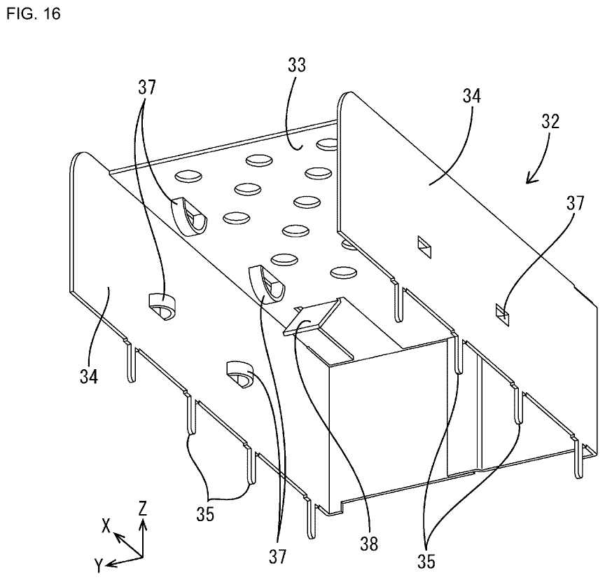

As shown in FIG. 3, a holding member 32 constituting a part of the substrate unit 20 is attached to the circuit substrate 21. The holding member 32 is a single member having a rectangular parallelepiped box shape that is open on the front and bottom sides, and includes an upper plate portion 33 and left and right side plate portions 34. The holding member 32 is made of a conductive material such as metal or a conductive resin, and has a shielding function. As shown in FIGS. 6 and 16, the holding member 32 has a plurality of leg portions 35 protruding from lower edges of the left and right side plate portions 34. The holding member 32 is attached to the circuit substrate 21 by inserting the leg portions 35 into the connection holes 24, and soldering (not shown) the inserted portions. As shown in FIGS. 12 and 13, a connection space 36 surrounded by the circuit substrate 21 and the holding member 32 is formed above the circuit substrate 21. The connection space 36 is open forward. The substrate-side connector 28 is accommodated in a rear end region of the connection space 36.

As shown in FIGS. 6 and 16, each of the upper plate portion 33 and the left and right side plate portions 34 has a plurality of holding projections 37 formed thereon. Each of the holding projections 37 is formed by being cut and raised so as to protrude toward the interior of the holding member 32. As shown in FIGS. 12, 13, and 16, a pair of disengagement pressing portions 38 spaced apart in the left-right direction are integrally formed with the holding member 32. Each of the disengagement pressing portions 38 is formed by cutting and raising a part of the upper plate portion 33 so as to protrude toward the interior of the holding member 32. The disengagement pressing portion 38 protrudes in the form of a plate, obliquely downward and forward from the upper plate portion 33. The disengagement pressing portion 38 is elastically deformable in the front-rear direction, with an upper edge thereof that is continuous with the plate portion 33 serving as a support.

The first relay connector 40A is a connector having a shielding function, and includes one card edge connection portion 47 and a plurality of connection ports 67. The first relay connector 40A is attached to and removed from the circuit substrate 21 by inserting and removing the card edge connection portion 47 into and from the substrate accommodating space 29 of the substrate-side connector 28.

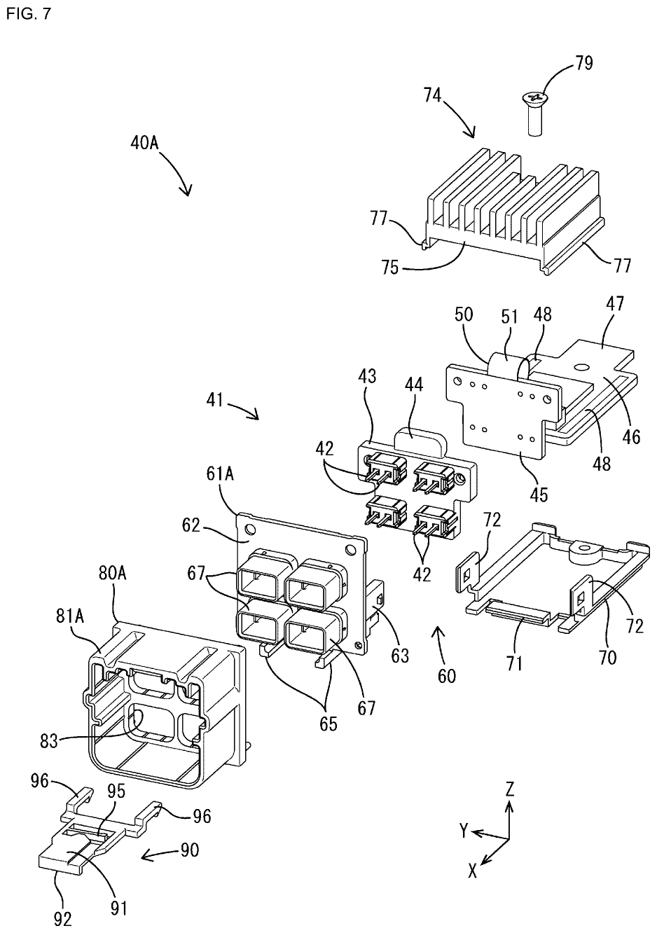

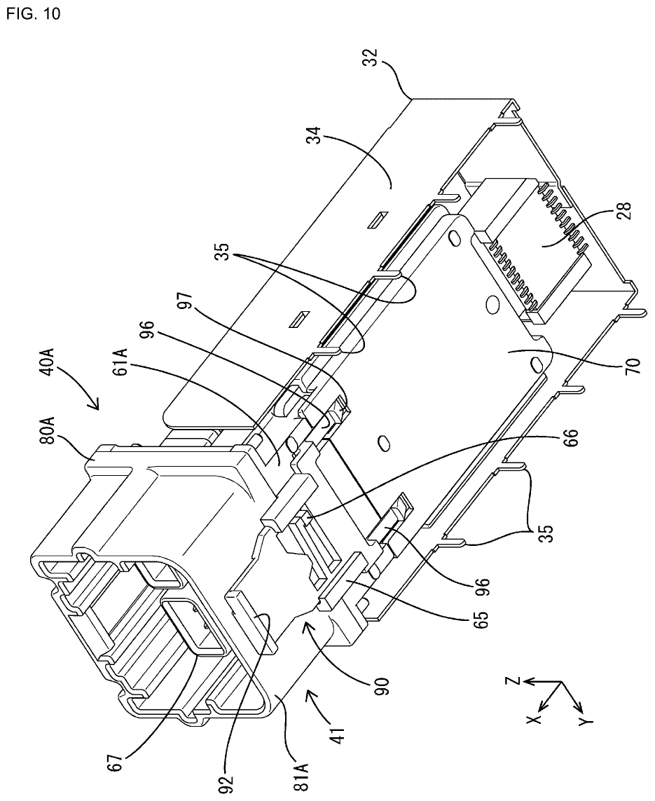

As shown in FIGS. 10, 12, and 13, the first relay connector 40A includes one connector body 41 and one retainer 90. As shown in FIG. 7, the connector body 41 includes four pairs of inner conductors 42, one dielectric 43, two sub-substrates 45 and 46, one outer conductor 60, and the first fitting member 80A. Each of the inner conductors 42 is formed by an elongated metal component. Each pair of inner conductors 42 constitute one differential pair circuit. A pair of inner conductors 42 constituting one differential pair circuit are disposed in one connection port 67. The dielectric 43 is a plate-shaped member having a thickness direction oriented in the front-rear direction. The inner conductors 42 are attached to the dielectric 43 so as to pass therethrough in the front-rear direction. As shown in FIGS. 7 to 9, a protection portion 44 protruding upward in the form of a wall is formed at an upper end portion of the dielectric 43.

As shown in FIGS. 7 to 9, of the two sub-substrates 45 and 46, the first sub-substrate 45 is mounted so as to be overlaid on a rear surface of the dielectric 43, with its thickness direction oriented in the front-rear direction. The inner conductors 42 are connected to the first sub-substrate 45 so as to pass therethrough. Of the two sub-substrates 45 and 46, the second sub-substrate 46 is disposed rearward of the first sub-substrate 45, with its thickness direction oriented in the up-down direction. The second sub-substrate 46 is disposed at the same height as a lower end portion of the first sub-substrate 45. A rear edge portion of the second sub-substrate 46 functions as the card edge connection portion 47. A pair of sub-ground circuits 48 that are elongated in the front-rear direction are formed on an upper surface of the second sub-substrate 46. The sub-ground circuits 48 are configured to be connected to the main ground circuits 23 of the circuit substrate 21 via the substrate-side connector 28.

An upper edge portion of the first sub-substrate 45 and a front edge portion of the second sub-substrate 46 are connected to each other via a flexible cable 50. A bent portion 51 of the flexible cable 50 is disposed above an upper edge of the first sub-substrate 45. The protection portion 44 of the dielectric 43 is disposed in the vicinity of the front of the bent portion 51 of the flexible cable 50.

As shown in FIGS. 7, 9, and 11, the outer conductor 60 is formed by assembling a first front member 61A, a lower case 70, and an upper case 74. The first front member 61A, the lower case 70, and the upper case 74 are all made of metal. Note that the lower case 70 may be made of synthetic resin.

The first front member 61A is a single component including a wall-shaped body portion 62 having a thickness direction oriented in the front-rear direction, a support plate portion 63, a pair of left and right support wall portions 64, a pair of left and right guide portions 65, and a projection-shaped pressing portion 66. The first front member 61A has four connection ports 67 formed thereon. Each of the connection ports 67 includes an opening portion extending through the wall-shaped body portion 62, and a rectangular tube portion protruding forward from the opening edge of the opening portion. The four connection ports 67 are aligned in the up-down direction and the left-right direction.

The support plate portion 63 extends rearward from a lower end portion of the wall-shaped body portion 62, with its thickness direction oriented in the up-down direction. The pair of support wall portions 64 extend rearward from the wall-shaped body portion 62, with their thickness direction oriented in the left-right direction. The pair of guide portions 65 are disposed on a lower end portion of the first front member 61A, and are shaped to extend in the front-rear direction. The projection-shaped pressing portion 66 is disposed on a lower surface of the first front member 61A at a position leftward of the center in the left-right direction. The first front member 61A is attached to a front surface of the dielectric 43, with the wall-shaped body portion 62 being overlaid on the front surface. The four pairs of inner conductors 42 attached to the dielectric 43 are disposed such that each pair of the inner conductors 42 pass through the corresponding connection port 67. A pair of inner conductors 42 are disposed in one connection port 67.

As shown in FIG. 7, the lower case 70 is a single component having an overall plate shape with its thickness direction oriented in the up-down direction. At a front edge portion of the lower case 70, a stepped portion 71 that is bent in a side view of the lower case 70 as viewed from the side is formed. The lower case 70 includes a pair of side wall portions 72 standing upward from front end portions of left and right side edges of the lower case 70. The lower case 70 is mounted to a lower end portion of the first front member 61A so as to extend rearwardly and horizontally. The first front member 61A and the lower case 70 are held in an assembled state by placing the stepped portion 71 on the support plate portion 63, placing the side wall portions 72 on the outer side surfaces of the support wall portion 64, and performing positioning with projections and recesses. The second sub-substrate 46 is placed on an upper surface of the lower case 70.

As shown in FIG. 7, the upper case 74 is a single component including a plate-shaped base portion 75 having a thickness direction oriented in the up-down direction, and grounding ribs 77 formed at left and right side edges of the plate-shaped base portion 75. The upper case 74 is placed on the second sub-substrate 46. The lower case 70, the second sub-substrate 46, and the upper case 74 are fixed with a screw 79 passed through a rear end portion of the plate-shaped base portion 75, the second sub-substrate 46, and a rear end portion of the lower case 70. The upper case 74 covers the entire upper surface of the second sub-substrate 46. The pair of grounding ribs 77 are connected to the sub-ground circuits 48 of the second sub-substrate 46.

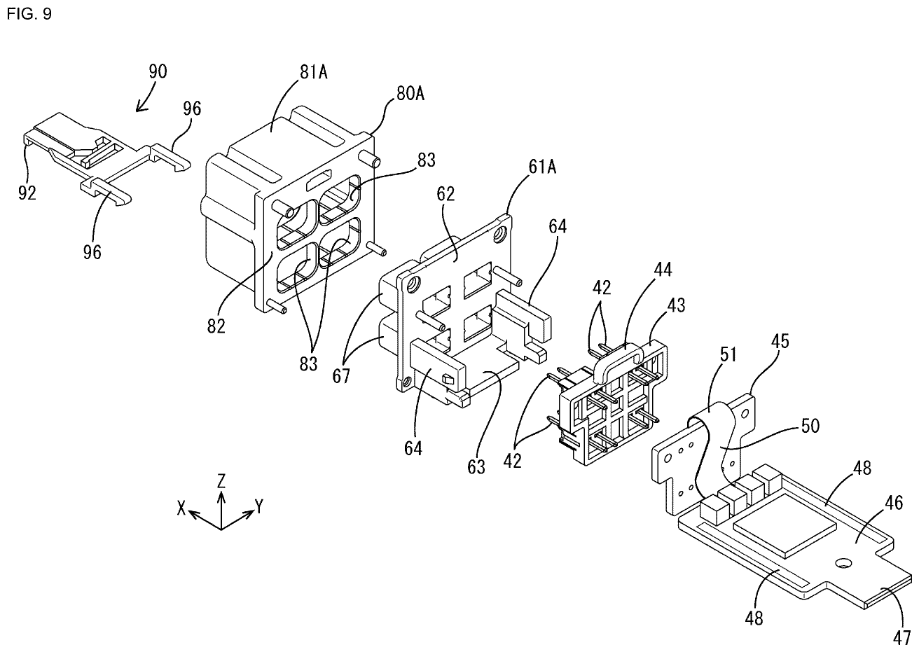

The first fitting member 80A is a single component made of synthetic resin. As shown in FIGS. 7 and 9, the first fitting member 80A includes a first hood portion 81A having a rectangular tubular shape, and a rear plate portion 82 covering a rear surface of the first hood portion 81A. The rear plate portion 82 has four attachment holes 83 formed therein. The first fitting member 80A is mounted to a front surface of the first front member 61A. The four connection ports 67 are respectively fitted to the four attachment holes 83, and are collectively surrounded by the first hood portion 81A.

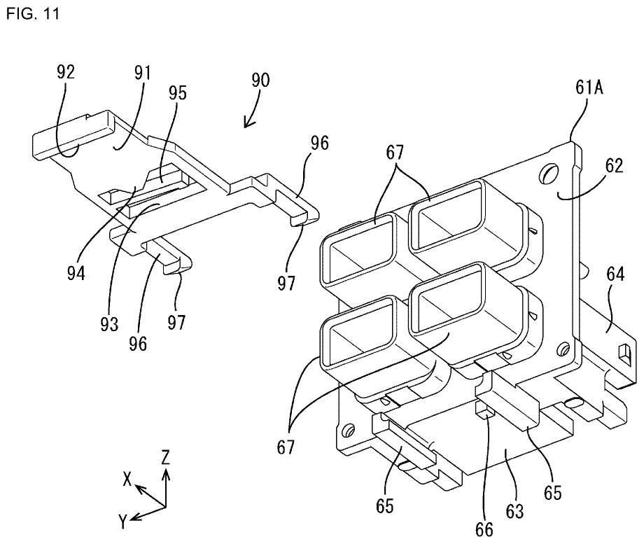

The retainer 90 is a single component made of synthetic resin, and is attached to the connector body 41. As shown in FIGS. 7 and 11, the retainer 90 includes a plate-shaped body portion 91 having a thickness direction oriented in the up-down direction, and a pair of bilaterally symmetrical lock arms 96. A front edge portion of the plate-shaped body portion 91 functions as an operation portion 92 for releasing locking. The plate-shaped body portion 91 has a rectangular operating space 93 formed therein so as to be open on both the front and back sides of the plate-shaped body portion 91. In the operating space 93, a projecting portion 94 protruding rearward from a front edge portion of the opening edge of the operating space 93 is disposed. An elastic arm portion 95 is disposed in a region inside the operating space 93 that is located rearward of the projecting portion 94. The elastic arm portion 95 is shaped to extend leftward in a cantilevered manner from a right edge portion of the opening edge of the operating space 93, and is elastically deformable in the front-rear direction. In the left-right direction, the projecting portion 94 is disposed at the same position as a central portion of the elastic arm portion 95 in the extension direction.

The pair of lock arms 96 are shaped to extend rearward in a cantilevered manner from rear end portions of left and right edges of the plate-shaped body portion 91. Front end portions of the lock arms 96 extend in a step-like shape, further outward in the left-right direction than the outer side surface of the plate-shaped body portion 91. A locking projection 97 protruding downward is formed at a rear end portion of each of the lock arms 96. The lock arm 96 is elastically deformable in the up-down direction.

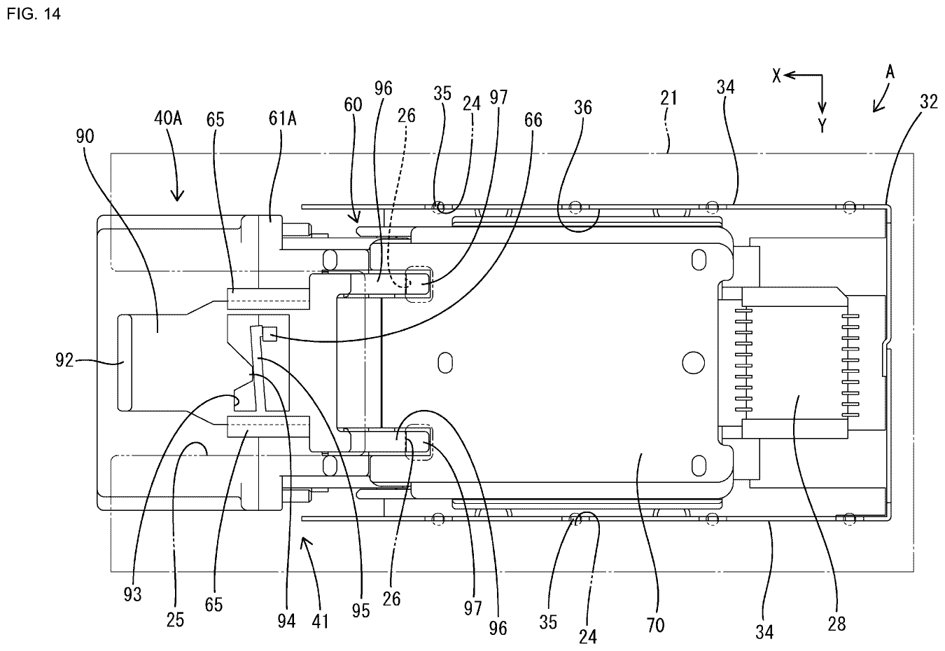

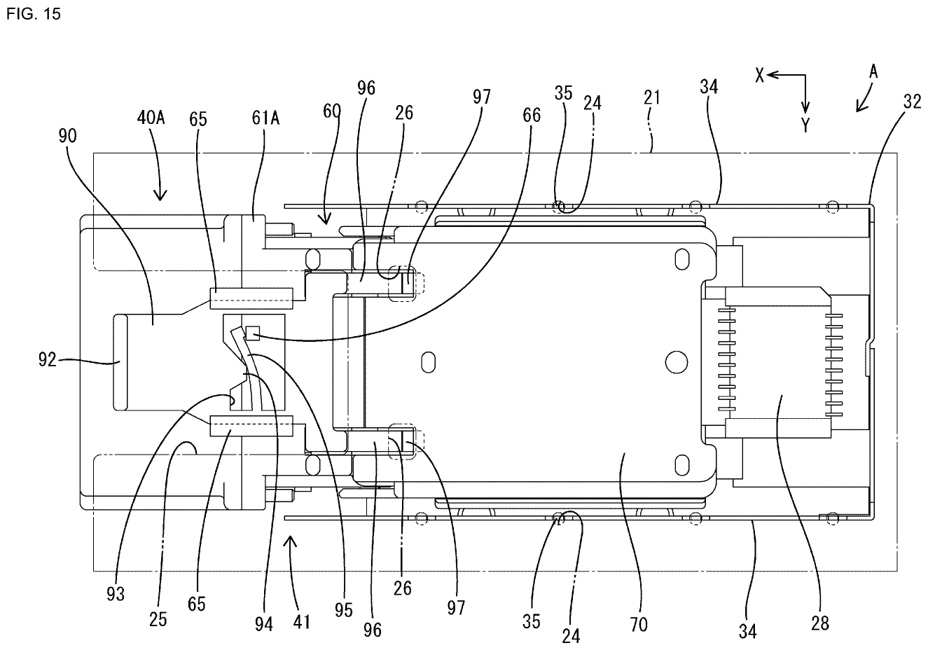

The retainer 90 is attached to the connector body 41, with the plate-shaped body portion 91 being placed on a lower end surface of the first front member 61A. Left and right side edges of the plate-shaped body portion 91 are slidably fitted to the pair of guide portions 65. The retainer 90 can move relative to the connector body 41 in the front-rear direction between a locked position (see FIGS. 12 and 14) and an unlocked position (see FIGS. 13 and 15) located rearward of the locked position. A projection-shaped pressing portion 66 of the outer conductor 60 is disposed in the operating space 93. The projection-shaped pressing portion 66 is disposed between a free end portion (extending end portion) of the elastic arm portion 95 and a rear edge portion of the opening edge of the operating space 93.

The second relay connector 40B has the same types of constituent components as those of the first relay connector 40A. Since the number of connection ports 67 of the first relay connector 40A and the number of connection ports 67 of the second relay connector 40B are different, the mounted components and the printed circuits of the sub-substrates 45 and 46 of the second relay connector 40B are different from those of the first relay connector 40A. The size and the shape of the second front member 61B of the second relay connector 40B are different from those of the first front member 61A of the first relay connector 40A. The size and the shape of the second hood portion 81B formed on the second fitting member 80B of the second relay connector 40B are also different from those of the first hood portion 81A of the first relay connector 40A. The eight connection ports 67 formed in the second front member 61B are divided into upper and lower rows, with four connection ports 67 arranged in the left-right direction in each row. The height dimension of the second fitting member 80B is the same as that of the first fitting member 80A, whereas the width dimension of the second fitting member 80B is larger than that of the first fitting member 80A.

When attaching the first relay connector 40A to the circuit substrate 21, the first front cover 12A is removed from the housing body 11 in which the substrate unit 20 is accommodated. Then, the connector body 41 is accommodated inside the connection space 36 from the front side of the circuit substrate 21 with the first fitting member 80A held between fingers. Inside the connection space 36, the holding projections 37 come into slidable contact with the outer surface of the connector body 41, thus positioning the connector body 41 relative to the circuit substrate 21 in the up-down direction and the left-right direction. By this positioning action, the card edge connection portion 47 of the first relay connector 40A is inserted into the substrate accommodating space 29. Inside the substrate accommodating space 29, the terminal fittings 30 come into elastic contact with the card edge connection portion 47. As a result of the foregoing, the substrate-side connector 28 and the first relay connector 40A are connected to each other, and the first relay connector 40A is attached to the circuit substrate 21.

In the process of attaching the first relay connector 40A, the guide portions 65 press the front end portions of the lock arms 96 rearward, and thus the retainer 90 moves together with the connector body 41. Immediately before completing connection between the two connectors 28 and 40A, the locking projections 97 ride on the mounting surface 22. Upon completing connection between the two connectors 28 and 40A, the lock arms 96 are elastically returned downward, thus causing the locking projections 97 to be locked to the locking holes 26. By this locking action, the retainer 90 is held in a state in which its forward displacement relative to the circuit substrate 21 is restricted.

In the process of connecting the two connectors 28 and 40A, the disengagement pressing portions 38 of the holding member 32 are elastically displaced rearward by being pressed by the upper case 74. In a state in which connection between the two connectors 28 and 40A has been completed, the connector body 41 is pressed in a direction in which the connector body 41 is disengaged forward from the substrate-side connector 28 by the elastic restoring force of the disengagement pressing portions 38. This pressing force causes the projection-shaped pressing portion 66 to push the free end portion (left end portion) of the elastic arm portion 95 forward, and thus the elastic arm portion 95 is elastically displaced forward to abut against the projecting portion 94.

When the elastic restoring force of the elastic arm portion 95 that has been elastically displaced forward, the elastic restoring force of the disengagement pressing portions 38 that have been elastically deformed rearward, the frictional resistance between the holding projections 37 and the connector body 41, and the frictional resistance between the card edge connection portion 47 and the terminal fittings 30 are balanced, the attachment position of the first relay connector 40A to the circuit substrate 21 is determined (see FIGS. 12 and 14). In a state in which the first relay connector 40A is attached to the circuit substrate 21, the plate-shaped body portion 91 of the retainer 90 is accommodated inside the cut-out portion 25 of the circuit substrate 21.

After the first relay connector 40A has been attached to the circuit substrate 21, the first front cover 12A is attached to the housing body 11, thus forming the first housing 10A. The first connection opening 13A and the first hood portion 81A are fitted to each other without any large gap therebetween, and the four connection ports 67 are exposed to the exterior of the first housing 10A in the first connection opening 13A. The operation portion 92 of the retainer 90 is exposed to the exterior of the first housing 10A in the first connection opening 13A. As a result of the foregoing, the assembly of the communication connector apparatus A in the first assembled configuration is completed.

When removing the first relay connector 40A attached to the circuit substrate 21, the operation portion 92 of the retainer 90 is pushed into the first housing 10A so as to be moved toward the unlocked position. In the process of pushing the retainer 90, the lock arms 96 are elastically displaced upward by the inclination of the locking projections 97, and the locking projections 97 are disengaged upward from the locking holes 26, and ride on an upper surface of the front edge portion of the lower case 70. This enables the retainer 90 and the connector body 41 to be moved forward relative to the circuit substrate 21.

Note that in the process of moving the retainer 90 to the unlocked position, the free end portion of the elastic arm portion 95 abuts against the projection-shaped pressing portion 66. Accordingly, the projecting portion 94 presses the central portion of the elastic arm portion 95 in the left-right direction from the front, thus elastically deforming the elastic arm portion 95 so as to bulge rearward. Once the amount of the elastic deformation of the elastic arm portion 95 reaches a certain level, the retainer 90 can no longer be pushed further in the unlocking direction. The position of the retainer 90 at this time is the unlocked position.

When the fingers holding the operation portion 92 are released after the retainer 90 has been pushed into the unlocked position, the connector body 41 is pushed forward by the elastic force of the disengagement pressing portions 38, causing the first hood portion 81A to protrude forward of the first front cover 12A. Following this operation, the projection-shaped pressing portion 66 presses the elastic arm portion 95 and the projecting portion 94 forward, and thus the retainer 90 moves forward relative to the connector body 41 and returns to the locked position. Thereafter, the first relay connector 40A may be simply pulled forward with the first hood portion 81A held between fingers.

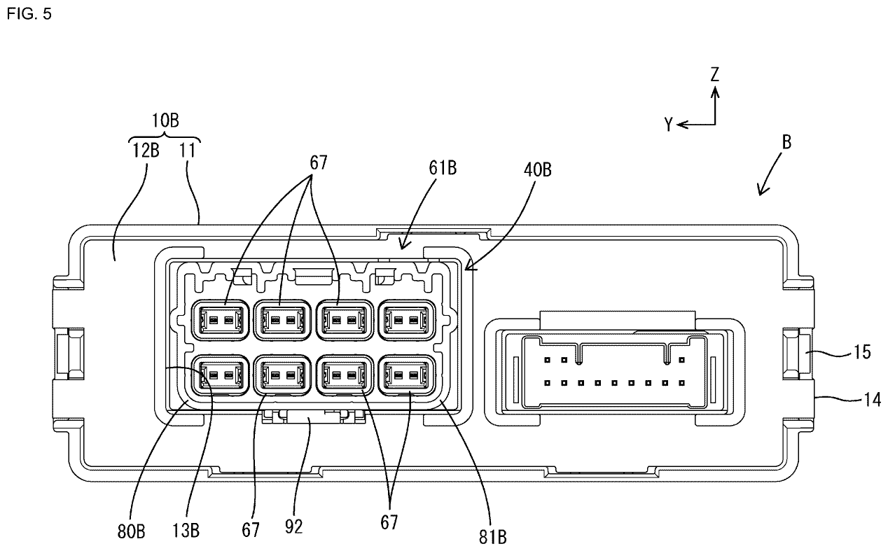

When attaching the second relay connector 40B to the substrate unit 20 after the first relay connector 40A has been removed, the first front cover 12A is removed from the housing body 11, and the second relay connector 40B is attached to the circuit substrate 21 through the same procedure as that used for the first relay connector 40A. After the second relay connector 40B has been connected to the substrate-side connector 28, the second front cover 12B may be attached to the housing body 11, thus forming the second housing 10B as shown in FIG. 5. As a result of the foregoing, the assembly of the communication connector apparatus B in the second assembled configuration is completed. The procedure for removing the second relay connector 40B is the same as that used for the first relay connector 40A. In the case where the number of connection ports 67 is the same and the transmission speed is to be changed, the relay connector may be replaced with a different relay connector (not shown) including different sub-substrates, without changing the front cover 12A or 12B.

The communication connector apparatuses A and B according to Embodiment 1 each include a circuit substrate 21, and a relay connector 40A or 40B. The circuit substrate 21 has a circuit 27 and a substrate-side connector 28 mounted thereon. The relay connectors 40A and 40B each include connection ports 67 to which device-side connectors 1 of communication conductive paths 3 are to be connected, and are each be attachable to and removable from the substrate-side connector 28. In the case of changing the number and the transmission speed of the communication devices 2, the relay connector need only be replaced with a relay connectors 40A or 40B corresponding to the number and the transmission speed of the connection ports 67. There is no need to replace the circuit 27 and the substrate-side connector 28 that are mounted on the circuit substrate 21. According to Embodiment 1, it is possible to accommodate changes in the communication devices 2 without replacing the circuit substrate 21.

The communication connector apparatuses A and B each include a housing 10A or 10B that accommodates the circuit substrate 21 and the relay connector 40A or 40B. The housings 10A and 10B each include a housing body 11 that is open on the front side, and a front cover 12A or 12B that is attachable to and removable from the opening of the housing body 11. The relay connectors 40A and 40B include hood portions 81A and 81B, respectively, that each surround the connection ports 67. The front covers 12A and 12B have connection openings 13A and 13B, respectively, formed therein to expose the hood portions 81A and 81B, respectively, and the connection ports 67 to the exterior of the housings 10A and 10B, respectively. In the case of replacing the relay connector 40A or 40B with a different relay connector 40A or 40B having a different number of connection ports 67, only the front cover 12A or 12B may be replaced with a front covers 12A or 12B having the connection opening 13A or 13B that matches the size of the hood portion 81A or 81B, instead of replacing the entire housing 10A or 10B. This can prevent a large gap from being formed between the connection opening 13A or 13B and the hood portion 81A or 81B.

The relay connectors 40A and 40B each include an outer conductor 60, and sub-substrates 45 and 46 configured to be connected to the substrate-side connector 28. Preferably, the outer conductor 60 is disposed so as to cover the sub-substrates 45 and 46. With this configuration, the communication circuit can be stabilized by the shielding function of the outer conductor 60.

The circuit substrate 21 is provided with a holding member 32 that holds the relay connector 40A or 40B in a positioned state. The relay connectors 40A and 40B that are attachable to and removable from the circuit substrate 21 can be stably held by the holding member 32. This can provide a reliable connection between each of the relay connectors 40A and 40B and the substrate-side connector 28. The holding member 32 has a box shape, and covers the relay connector 40A or 40B. The holding member 32 is made of a conductive material, and also have the shielding function. Accordingly, a fewer number of components are required than in the case of providing a dedicated shielding function member separately from the holding member 32.

The relay connectors 40A and 40B each include a retainer 90 that is locked to the circuit substrate 21 to hold the relay connector 40A or 40B in an attached state to the circuit substrate 21. The circuit substrate 21 is provided with disengagement pressing portions 38 that press the relay connector 40A or 40B in a direction in which the relay connector 40A or 40B is disengaged from the circuit substrate 21. With this configuration, simply detaching the retainer 90 from the circuit substrate 21 allows each of the relay connectors 40A and 40B to be disengaged from the circuit substrate 21 by the disengagement pressing portions 38. Accordingly, the disengagement can be performed with good workability.

The retainer 90 includes a plate-shaped body portion 91 (extension portion) disposed on a surface thereof opposed to a mounting surface 22 of the relay connector 40A or 40B. In a state in which the relay connector 40A or 40B is attached to the circuit substrate 21, the plate-shaped body portion 91 is accommodated inside a cut-out portion 25 formed in the circuit substrate 21. Since the plate-shaped body portion 91 is accommodated within the range of the thickness of the circuit substrate 21, the height of the circuit substrate 21 in the thickness direction can be reduced as compared with a case where the plate-shaped body portion 91 is placed on the mounting surface 22 of the circuit substrate 21. The cut-out portion 25 is disposed only within the range of a region of the mounting surface 22 that is covered by the relay connector 40A or 40B. The mounting surface 22 of the circuit substrate 21 can be effectively utilized to place circuits, elements, and the like.

The relay connectors 40A and 40B each include inner conductors 42, a dielectric 43, the outer conductor 60, and the sub-substrates 45 and 46. The sub-substrates 45 and 46 include a first sub-substrate 45 disposed so as to be overlaid on a back surface of the dielectric 43, and a second sub-substrate 46 connected to the first sub-substrate 45 via a flexible cable 50. A protection portion 44 that covers a part of the flexible cable 50 that protrudes from a peripheral edge of the first sub-substrate 45 is formed on the dielectric 43. This configuration can prevent the flexible cable 50 from being deformed due to interference with a foreign object.

### Embodiment 2

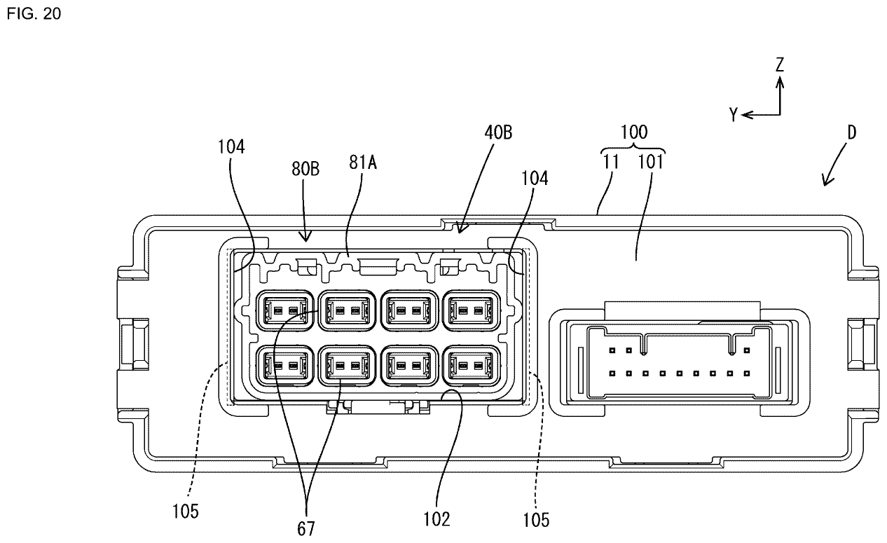

Embodiment 2 as an implementation of the present disclosure will be described with reference to FIGS. 19 and 20. Communication connector apparatuses C and D according to Embodiment 2 differ from the communication connector apparatuses according to Embodiment 1 above in that they include only one type of housing, a housing 100. The rest of the configuration is the same as that of Embodiment 1 above. Therefore, the same components are denoted by the same reference numerals, and descriptions of structures, operations, and effects thereof have been omitted. In Embodiment 2, as for a left-right direction, the positive direction of the Y axis in FIGS. 19 and 20 is defined as the rightward direction. As for an up-down direction, the positive direction of the Z axis in FIGS. 19 and 20 is defined as the upward direction.

As in the case of Embodiment 1, in Embodiment 2, a first assembled configuration (see FIG. 19) in which a first relay connector 40A including four connection ports 67 is attached to a substrate unit (not shown), and a second assembled configuration (see FIG. 20) in which a second relay connector 40B including eight connection ports 67 is attached to a substrate unit will also be described as examples of the assembled configuration of the communication connector apparatuses C and D. The communication connector apparatus C is formed by the first assembled configuration. The communication connector apparatus D is formed by the second assembled configuration.

The substrate unit, the first relay connector 40A, and the second relay connector 40B are the same as those of Embodiment 1. The same housing 100 is used for the first assembled configuration and the second assembled configuration. The housing 100 is formed by assembling a housing body 11 and a front cover 101. The housing body 11 is the same as that of Embodiment 1.

The front cover 101 has a connection opening 102 having a rectangular opening shape. The connection opening 102 is configured to expose the first hood portion 81A of the first relay connector 40A and the second hood portion 81B of the second relay connector 40B therein. A pair of bilaterally symmetrical movable covers 104 are integrally formed with the front cover 101. The movable covers 104 have a rectangular plate shape, and are linked to the front cover 101 via hinges 105 respectively extending along left and right side edges of the opening edge of the connection opening 102. The movable covers 104 are rotatable between a closed position and an open position with the hinges 105 serving as supports.

As shown in FIG. 19, in a state in which the movable covers 104 are at the closed position, left and right side edge portions of the connection opening 102 are covered by the movable covers 104. In this state, the opening range of the connection opening 102 is reduced to be narrower than the entire opening area of the connection opening 102, and has the minimum size required to expose the first hood portion. As shown in FIG. 20, in a state in which the movable covers 104 are at the open position, the opening range of the connection opening 102 becomes the maximum opening area of the connection opening 102. This opening range is appropriately sized to expose the second hood portion. In the first assembled configuration in which the first relay connector 40A is attached to the substrate unit, the movable covers 104 are displaced to the closed position. In the second assembled configuration in which the second relay connector 40B is attached to the substrate unit, the movable covers 104 are displaced to the closed position.

The communication connector apparatuses C and D according to Embodiment 2 each include a housing 100 capable of accommodating a circuit substrate (not shown) and a first relay connector 40A, and also capable of accommodating a circuit substrate and a second relay connector 40B. The first relay connector 40A includes a first hood portion 81A that surrounds four connection ports 67, and the second relay connector 40B includes a second hood portion 81B that surrounds eight connection ports 67. The housing 100 has a connection opening 102 formed therein to expose the first hood portion 81A or the second hood portion 81B to the exterior of the housing 100. The connection opening 102 is provided with movable covers 104 that are displaceable so as to change the opening region of the connection opening 102. The movable covers 104 are linked to a front cover 101 of the housing 100 via hinges 105.

This configuration allows the movable covers 104 to be displaced with the hinges 105 serving as supports, thus changing the opening size of the connection opening 102. In the case of replacing the relay connector 40A or 40B with a different relay connector 40A or 40B including a different numbers of the connection ports 67, the movable covers 104 are displaced according to the size of the first hood portion 81A or the second hood portion 81B. This can prevent a large gap from being formed between the connection opening 102 and the first hood portion 81A, and between the connection opening 102 and the second hood portion 81B.

### Embodiment 3

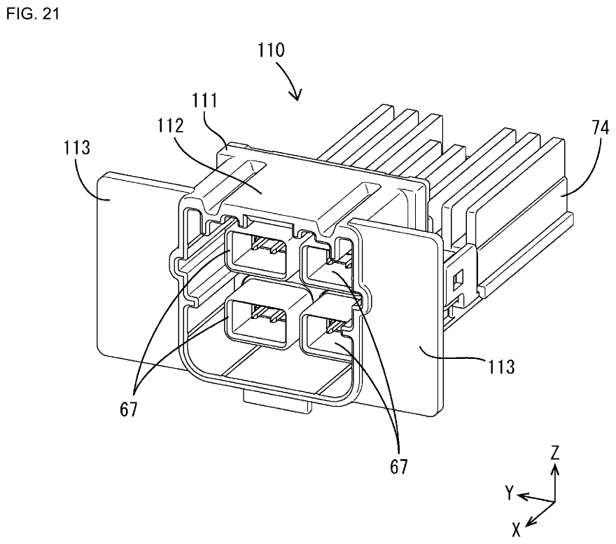

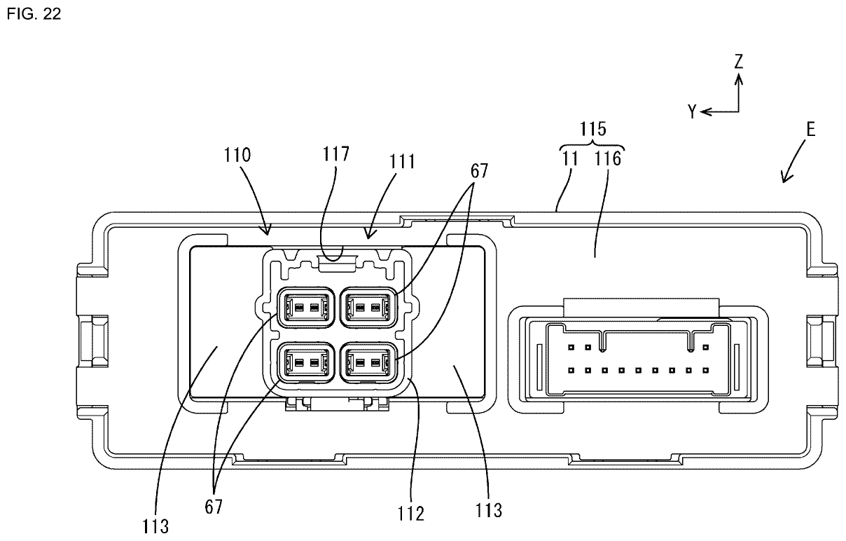

Embodiment 3 as an implementation of the present disclosure will be described with reference to FIGS. 21 to 23. Communication connector apparatuses E and F according to Embodiment 3 differ from the communication connector apparatuses according to Embodiment 1 above in the configuration of the first relay connector 110, and include only one type of housing, a housing 115. The rest of the configuration is the same as that of Embodiment 1 above. Therefore, the same components are denoted by the same reference numerals, and descriptions of structures, operations, and effects thereof have been omitted. In Embodiment 3, as for a left-right direction, the positive direction of the X axis in FIG. 21 is defined as the forward direction. As for a left-right direction, the positive direction of the Y axis in FIGS. 21 to 23 is defined as the rightward direction. As for an up-down direction, the positive direction of the Z axis in FIGS. 21 to 23 is defined as the upward direction.

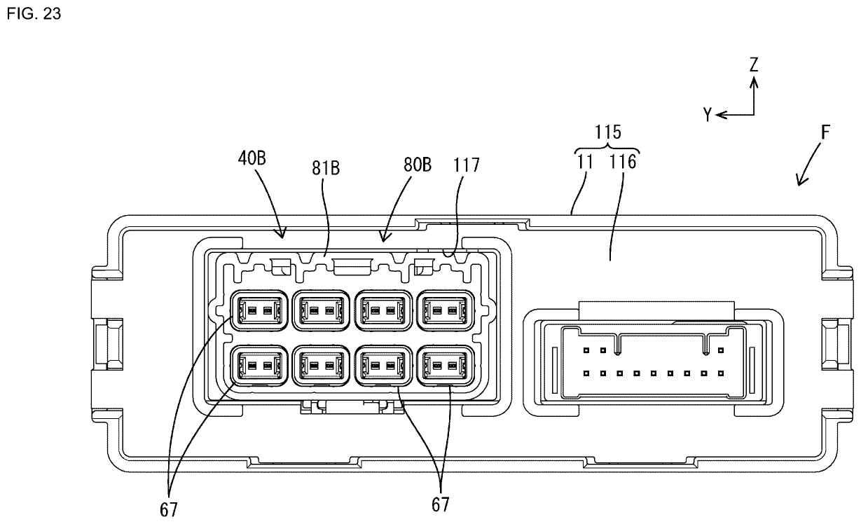

As in the case of Embodiment 1, in Embodiment 3, a first assembled configuration (see FIG. 22) in which a first relay connector 110 including four connection ports 67 is attached to a substrate unit (not shown), and a second assembled configuration (see FIG. 23) in which a second relay connector 40B including eight connection ports 67 is attached to a substrate unit will also be described as examples of the assembled configuration of the communication connector apparatuses E and F. The communication connector apparatus E is formed by the first assembled configuration. The communication connector apparatus F is formed by the second assembled configuration.

The substrate unit and the second relay connector 40B are the same as those of Embodiment 1. The housing 115 is the same as the second housing 10B of Embodiment 1, and is formed by assembling a housing body 11 and a front cover 116. The front cover 116 is the same as the second front cover 12B of Embodiment 1. The same housing 115 is used for the first assembled configuration and the second assembled configuration.

Constituent members of the first relay connector 110 that are other than the first fitting member 111 are the same as those of the first relay connector 40A of Embodiment 1. The first fitting member 111 of Embodiment 3 differs from the first fitting member 80A of Embodiment 1 in that it includes a pair of covering portions 113. The two covering portions 113 extend in a plate shape, outwardly in the left-right direction from left and right side edges, respectively, at a front edge of the first hood portion 112. The covering portions 113 partly cover the connection opening 117 of the front cover 116 while the first relay connector 110 is attached to the substrate unit.

As shown in FIG. 22, in the first assembled configuration in which the first relay connector 110 is used, the first hood portion 112 is disposed in a central region, in the left right direction, in the opening range of the connection opening 117, and the two covering portions 113 are located in left and right end regions, respectively, in the opening range of the connection opening 117. No large gaps are formed between the connection opening 117 and the first hood portion 112. As shown in FIG. 23, in the second assembled configuration in which the second relay connector 40B is used, the second hood portion 81B of the second relay connector 40B is disposed so as to close the entire region in the opening range of the connection opening 117. No large gaps are formed between the connection opening 117 and the second hood portion 81B.

The communication connector apparatuses E and F each include a housing 115 capable of accommodating a circuit substrate and a first relay connector 110, and also capable of accommodating a circuit substrate and a second relay connector 40B. The first relay connector 110 includes a first hood portion 112 that surrounds connection ports 67. The housing 115 has a connection opening 117 formed therein to expose the first hood portion 112 or the second hood portion 81B to the exterior of the housing 115. Covering portions 113 that partly cover the connection opening 117 are integrally provided with the first hood portion 112. By determining whether or not to provide the covering portions 113 and setting the size of the covering portions 113 according to the size of the hood portion 81B or 112, it is possible to prevent a large gap from being formed between the connection opening 117 and the first hood portion 112, and between the connection opening 117 and the second hood portion 81B, without changing the size of the connection opening 117.

### Embodiment 4

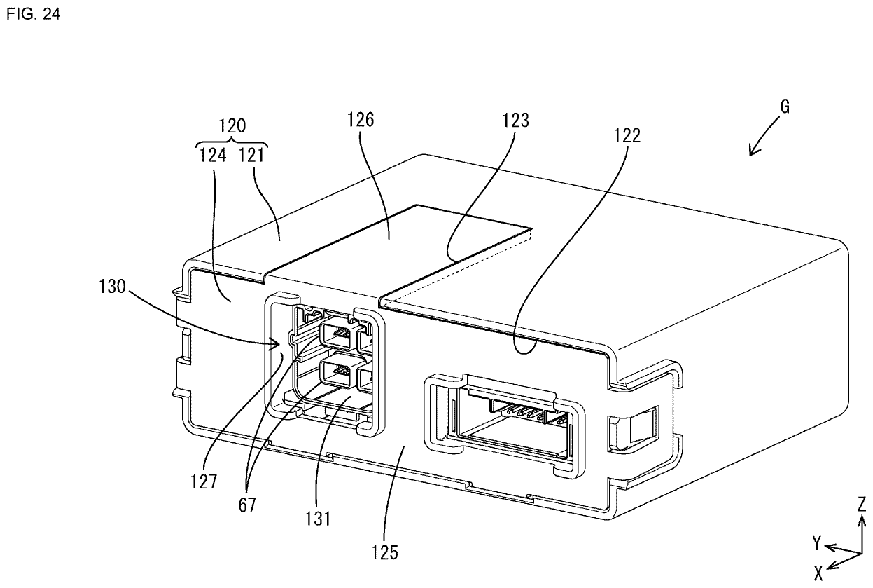

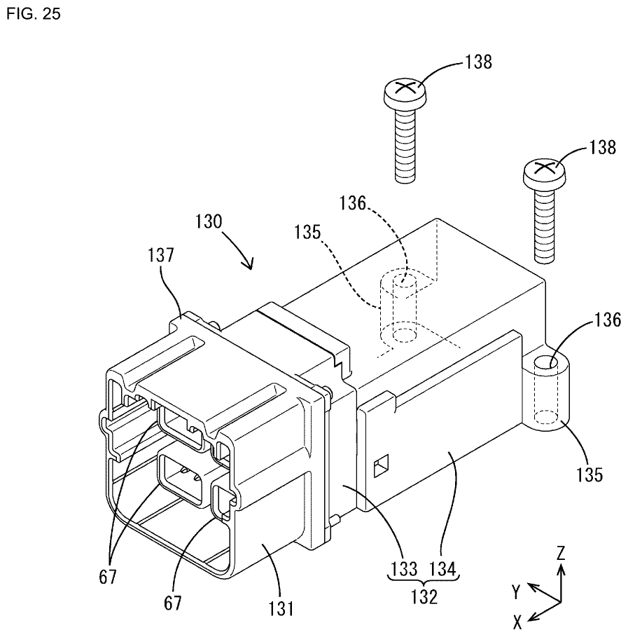

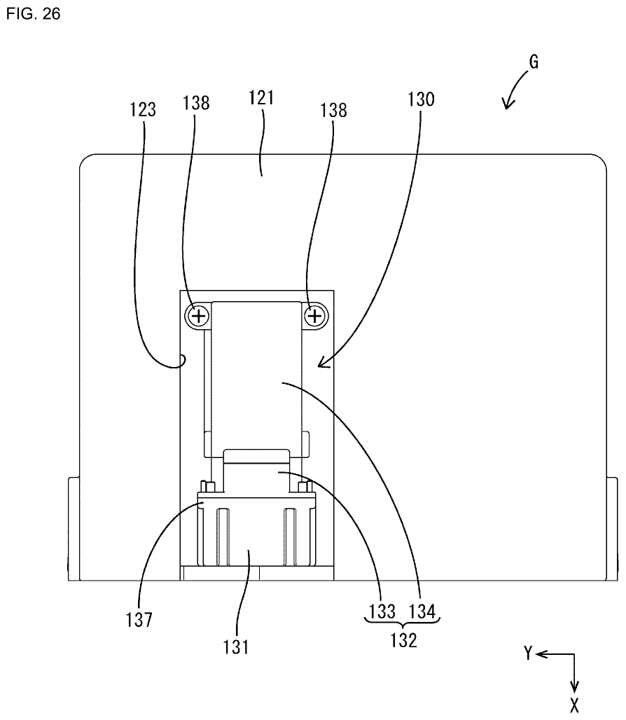

Embodiment 4 as an implementation of the present disclosure will be described with reference to FIGS. 24 to 26. A communication connector apparatus G according to Embodiment 4 uses a first housing 120 that differs from the first housing of Embodiment 1 above, and a first relay connector 130 that differs from the first relay connector of Embodiment 1. The rest of the configuration is the same as that of Embodiment 1 above. Therefore, the same components are denoted by the same reference numerals, and descriptions of structures, operations, and effects thereof have been omitted. In Embodiment 4, as for a left-right direction, the positive direction of the X axis in FIGS. 24 to 26 is defined as the forward direction. As for a left-right direction, the positive direction of the Y axis in FIGS. 24 to 26 is defined as the rightward direction. As for an up-down direction, the positive direction of the Z axis in FIGS. 24 and 25 is defined as the upward direction.

In Embodiment 4, a first assembled configuration in which a first relay connector 130 including four connection ports 67 is attached to a substrate unit (not shown) will be described as an example of the assembled configuration of the communication connector apparatus G. The substrate unit (not shown) is the same as that of Embodiment 1. The first housing 120 is formed by assembling a first housing body 121 and a first front cover 124. The first housing body 121 has an overall rectangular parallelepiped box shape as in the case of Embodiment 1. The front side of the first housing body 121 is formed as a front opening portion 122 that is open in the entire region. An upper opening portion 123 is formed in an upper surface of the first housing body 121. The upper opening portion 123 is formed by cutting out an area including the region in which the first relay connector 130 is to be disposed in a plan view. The upper opening portion 123 is in communication with the front opening portion 122.

The first front cover 124 is a single component including a cover body portion 125 and an upper lid portion 126. The cover body portion 125 has the same shape as that of the first front cover 12A of Embodiment 1, and has a first connection opening 127 for exposing a first hood portion 131 of the first relay connector 130. The upper lid portion 126 is a plate-shaped portion extending rearward at a right angle from an upper edge of the cover body portion 125.

The first relay connector 130 is formed by assembling inner conductors (not shown), a dielectric (not shown), sub-substrates (not shown), an outer conductor 132, and a first fitting member 137. The outer conductor 132 is formed by assembling a front member 133 and a rear member 134. The rear member 134 has a rectangular parallelepiped box shape that is open on the front side, and is disposed so as to cover a rear surface of the front member 133. The inner conductors (not shown), the dielectric (not shown), and the sub-substrates (not shown) are accommodated inside the rear member 134. The rear member 134 has a pair of left and right attachment portions 135 formed thereon. The attachment portions 135 are disposed at rear end portions of outer side surfaces of the rear member 134. Each of the attachment portions 135 has a through hole 136 extending therethrough in the up-down direction. The first hood portion 131 is formed on the first fitting member 137.

In the first assembled configuration, the first relay connector 130 is attached to the substrate unit inside the first housing body 121, with the first front cover 124 removed from the first housing body 121. At the time of attachment, the first relay connector 130 is accommodated inside the first housing body 121, and then connected to a substrate-side connector (not shown). Thereafter, bolts 138 are inserted from above the first housing body 121 into the through holes 136 through the upper opening portion 123, and then screwed to be fastened to attachment holes (not shown) of a circuit substrate. As a result of fastening the bolts 138, the first relay connector 130 is fixed to the circuit substrate.

After this, the first front cover 124 is mounted to the first housing body 121. Upon mounting the first front cover 124, the cover body portion 125 closes the front opening portion 122 of the first housing body 121, and the upper lid portion 126 closes the upper opening portion 123. The first hood portion 131 of the first fitting member 137 is exposed from the first connection opening 127. As a result of the foregoing, the assembly of the communication connector apparatus G in the first assembled configuration is completed. When removing the first relay connector 130 from the substrate unit, the operation is performed by reversing the above-described procedure.

When connecting a second relay connector (not shown) including eight connection ports 67 to the substrate unit, a second housing (not shown) for a second assembled configuration is used. The second housing is formed by assembling a second housing body and a second front cover. The second housing body has formed therein an upper opening portion having a size different from that of the first housing body 121. The second front cover includes an upper lid portion for closing the upper opening portion, and a second connection opening for exposing a second hood portion of the second relay connector. The second relay connector is composed of components similar to those of the first relay connector 130. As in the case of the first relay connector 130, the second relay connector is also fixed to the substrate unit using screws (not shown) inserted from the upper opening portion.

### Other Embodiments

The present disclosure is not limited to the embodiments described by the above statements and drawings, but is defined by the claims. The present disclosure includes all modifications which fall within the scope of the claims and the meaning and scope of equivalent thereof, and also includes the following embodiments.

The communication connector apparatus according to the present disclosure is not only applicable to communication circuits based on Ethernet, but also applicable to communication circuits based on a protocol other than Ethernet. The communication connector apparatus according to the present disclosure is also applicable to a relay connector that does not include an outer conductor.

The circuit substrate need not be provided with a disengagement pressing portion.

The holding member need not have a shielding function.

The holding member may have a shape other than a box shape.

The retainer may be configured to be detached from the circuit substrate by being pulled from the circuit substrate while being locked thereto.

The extension portion of the retainer may be placed on the mounting surface of the circuit substrate.

At least a part of the cut-out portion may be disposed in a region of the mounting surface that is not covered by the relay connector.

A connection port does not represent a structural feature of a specific component of a relay connector, but represents a portion of a relay connector that has a connection function. Accordingly, the connection port is not limited to a connection port formed in the outer conductor, and may be formed in a member other than the outer conductor, or may be composed of a plurality of members.

In Embodiment 2, the movable covers may be configured to be separable from the housing, or may be configured to be slidable as sliding doors.

In Embodiments 2 and 3, the housings may each be formed as a single component, instead of being separated into a housing body and a front cover.

1. A communication connector apparatus comprising:
a circuit substrate having a substrate-side connector mounted thereon; and
a relay connector including a connection port to which a device-side connector of a communication conductive path is to be connected, and being attachable to and removable from the substrate-side connector.

2. The communication connector apparatus according to claim 1, further comprising
a housing configured to accommodate the circuit substrate and the relay connector,
wherein the housing includes a housing body that is open on a front side thereof, and a front cover that is attachable to and removable from the opening of the housing body,
the relay connector includes a hood portion configured to surround the connection port, and
the front cover has a connection opening formed therein to expose the hood portion to an exterior of the housing.

3. The communication connector apparatus according to claim 1, further comprising
a housing configured to accommodate the circuit substrate and the relay connector,
wherein the relay connector includes a hood portion configured to surround the connection port,
the housing has a connection opening formed therein to expose the hood portion to an exterior of the housing, and
the connection opening is provided with a movable cover that is displaceable so as to change an opening region of the connection opening.

4. The communication connector apparatus according to claim 3, wherein the movable cover is linked to the housing via a hinge.

5. The communication connector apparatus according to claim 1, further comprising
a housing configured to accommodate the circuit substrate and the relay connector,
wherein the relay connector includes a hood portion configured to surround the connection port,
the housing has a connection opening formed therein to expose the hood portion to an exterior of the housing, and
a covering portion configured to cover a part of the connection opening is provided as a single piece with the hood portion.

6. The communication connector apparatus according to claim 1,
wherein the relay connector includes an outer conductor, and a sub-substrate configured to be connected to the substrate-side connector, and
the outer conductor is disposed so as to cover the sub-substrate.

7. The communication connector apparatus according to claim 1, wherein the circuit substrate is provided with a holding member configured to hold the relay connector in a positioned state.

8. The communication connector apparatus according to claim 7,
wherein the relay connector includes an outer conductor,
the outer conductor is connected to the holding member, and
the holding member is made of a conductive material, is connected to a ground circuit of the circuit substrate, has a box shape, and covers the relay connector.

9. The communication connector apparatus according to claim 1,
wherein the relay connector includes a retainer configured to be locked to the circuit substrate to hold the relay connector in an attached state to the circuit substrate, and
the circuit substrate is provided with a disengagement pressing portion configured to press the relay connector in a direction in which the relay connector is disengaged from the circuit substrate.

10. The communication connector apparatus according to claim 1,
wherein the relay connector includes an inner conductor, a dielectric, an outer conductor, and a sub-substrate,
the sub-substrate includes a first sub-substrate disposed so as to be overlaid on a back surface of the dielectric, and a second sub-substrate connected to the first sub-substrate via a flexible cable, and
a protection portion configured to cover a part of the flexible cable that protrudes from a peripheral edge of the first sub-substrate is formed on the dielectric.
